(19) United States
(12) Patent Application Publication
(10) Pub. No.: US 2005/0133702 A1
(43) Pub. Date: Jun. 23, 2005

(54) Method and apparatus for monitoring surfaces

(75) Inventor: Christof J. Meyer, Bleibach (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sick AG, Waldkirch (DE)

(21) Appl. No.: 11/013,595

(22) Filed: Dec. 14, 2004

(30) Foreign Application Priority Data
Dec. 19, 2003 (DE) 103 59 782.4

(51) Int. Cl. G06M 7/00

(52) U.S. Cl. 250/221

(57) ABSTRACT

A method and apparatus for the monitoring of areas with several light emitters arranged alongside each other, which emit light along a light emitter cone, and several light receivers arranged alongside each other, which receive light from a light receiver cone. The emitters and receivers form several interacting pairs which can be activated individually, in temporal succession (sequentially) and/or cyclically by a control unit during a monitoring mode of operation. The distance of the light emitters from the corresponding light receivers is determined during a distance determining mode of operation from the number of light emitters visible to a light receiver and/or from the number of light receivers seeing a light emitter.

### BACKGROUND OF THE INVENTION

The invention concerns a method for the contact-free monitoring of areas with several light emitters and corresponding light receivers arranged alongside each other and forming several emitter/receiver pairs that work together to cover the area being monitored with several parallel light beams. The invention also relates to a device for carrying out such a method.

The above-mentioned methods and device are used, for example, to protect and isolate dangerous machine tools with multiple-beam light grids. For this, several light emitters and light receivers are arranged in a common housing on one side of the monitoring area. On the opposite side of the monitoring area is a retroreflector for reflecting the light from the light emitters back to the light receivers.

Such protective systems are also known as one-way systems, in which the light emitters are located on one side of the monitoring area, while the opposite side is bounded by the light receivers. In either case, the individual interacting pairs, each one comprising a light emitter and an associated light receiver, are sequentially activated by a control unit, one after the other. This process is cyclically repeated. In this way, an optical light grid is produced inside the monitoring area which can recognize an obstacle that interrupts at least one light beam from one of the light emitter to the associated light receiver. If an object is in the monitored area, a corresponding optical and/or acoustical warning signal is generated, and/or the dangerous machine is brought to a halt. To ensure a safe functioning, especially of light grids using the one-way system, even when exposed to impact and vibration at the place of use, the light emitters send out their light not in the form of a thin parallel light beam, but instead in the form of an emitted light cone. Similarly, the light receiver can receive light arriving at the receiver in the form of a reception light cone.

A drawback encountered with prior art systems is that the light density within the cone-shaped light beam decreases with an increase in the width of the monitoring field, i.e. an increase in the distance between the light emitter and receiver. This substantially reduces the signal strength or level generated by the light receiver from the incident light. As a result, the signal level typically lies within a large dynamic range, depending on the width of the monitored field. To confidently conclude that no object is located in the monitoring field, it is necessary for the normal signal strength to exceed an internal switching threshold of the light barrier or the light grid. The switching threshold must therefore be set so that even at the lowest, unobstructed signal strength the threshold will not be exceeded. But when the monitoring field width is relatively narrow, which results in a very high signal strength that is far above the switching threshold, the light barrier or light grid can experience operational problems. These problems are usually due to multiple reflections on obstacles or a sensitivity to spurious or background light. To avoid this, the switching threshold must be adapted to the monitoring field width. Switching threshold adaptations can be made at the factory, but that would lead to multiple device versions, which is uneconomical to both the manufacturer or the user. If this switch threshold adaptation is performed by the user, defective settings are possible, which can be dangerous and constitute a safety risk.

### BRIEF SUMMARY OF THE INVENTION

It is an object of the invention to provide a method and a device of the kind mentioned above for determining the effective width of the monitoring field and to then set the optimal switching threshold in dependence on the determined monitoring field width.

For this purpose, the present invention can operate the light grid or barrier in a distance determining mode to establish the distance of the light emitters from the light receivers based on the number of light emitters that are visible to a given light receiver and/or from the number of light receivers which can see a given light emitter. This is attained, for example, by sequentially activating all light emitters one after the other in time, but only one light receiver is in its active receive-ready mode during this time interval. The light receiver therefore receives one light signal after the other from each light emitter situated within the light reception cone of the receiver. A control unit uses the number of light signals identified by a light receiver to determine the monitoring field width by taking into account the size of the reception cone and the spacing between light emitters.

The apparatus of the present invention includes a control unit that has means for determining the number of light emitters that are visible from a light receiver and/or the number of light receivers that can see a given light emitter. From this, the distance between the light emitters and the light receivers is determined.

An advantage of the present invention is that with no additional optical or optoelectronic components, and by merely using a cyclical or situation-dependent switching between the monitoring mode and the distance determining mode as triggered by a control unit, the width of the monitoring field can be determined so that the optimal switching threshold for the light receivers when operating in the monitoring mode can be established. In this way, a light grid can be used for different monitoring field widths, without compromising the safe recognition of obstacles in the monitoring field, as can be caused, for example, by multiple reflections or the like.

In one preferred embodiment of the invention, it is not necessary to set the size of the light beam cone from the light emitters (the “sending cone”), or the size of the light receiving cone of the light receivers by means of costly adjustments to exact values during factory assembly of the apparatus. Instead, these values are determined independently during an ongoing teach-in process. For example, this can be carried out for a monitoring field of known width by determining the number of light emitters that are visible from a given light receiver and/or the number of light receivers which can see a given light emitter during the distance determining mode of operation. From this, the angle of the sending cone and/or that of the receiving cone can be calculated.

In another advantageous preferred embodiment of the invention, the distance information obtained while operating in the distance determining mode is correlated to the signal strength at the light receiver to establish the switching threshold. In this way, one can also factor in the degree of dirtiness or other contamination of the optical boundary surfaces and/or the age-related decrease in the efficiency of the individual optoelectronic components when the switching threshold is set. This has the major advantage of prolonging the time intervals between necessary cleaning of the boundary surfaces.

In another embodiment of the invention, a mean value is formed from a number of individual values obtained during the distance determining mode, which enhances the accuracy of determining the monitoring field width.

A further modification of the invention involves using the number of light emitters visible from a light receiver and/or the number of light receivers which can see a light emitter for mechanically aligning of the light emitters with the light receivers and vice versa. For this purpose, for example, the number of light emitters seen by the first light receiver is compared with the number of light emitters seen by the last light receiver. The light emitters and/or light receivers are then shifted or tilted relative to each other until the emitters and/or receivers are symmetrically distributed relative to each other.

The present invention further proposes to use the number of light emitters that are visible from a light receiver, as determined in the distance determining mode of operation and/or the number of light receivers that can see a light emitter for locating an object positioned in the monitoring field. If the object lies relatively closer to the light emitters, several of the light receivers will not receive any light from the covered light emitter(s). If the object is relatively closer to the light receiver, only one or only a few light receivers will be prevented from receiving light from the light emitters.

The invention will be further explained in more detail with reference to the drawings.

### BRIEF DESCRIPTION OF THE DRAWINGS

FIG. 1 shows a light grid for the monitoring of an area constructed in accordance with the present invention;

FIG. 2 is a view similar to FIG. 1 and shows an incorrect alignment of the light emitters and receivers; and

FIG. 3 shows use of the light grid of the present invention for locating an object.

### DESCRIPTION OF THE PREFERRED EMBODIMENTS

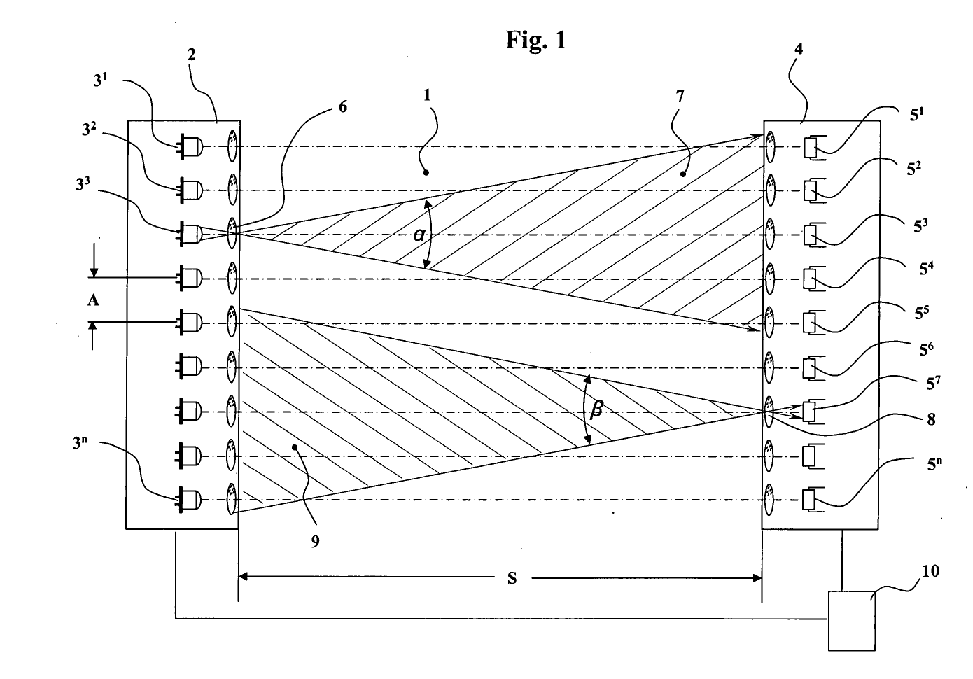

Referring to FIG. 1, on one side of a monitoring field 1, several light emitters 3¹, 3², 3³ to 3ⁿ, arranged alongside each other, are in an emitter housing 2. At the opposite side of the monitoring field 1, several light receivers 5¹, 5², 5³ to 5ⁿ are arranged alongside each other in a receiver housing 4. Transmission optics 6 are arranged in front of each light emitter 3 and shape the emitted light directed into the monitoring field into an emitter cone 7 with an emitter cone angle α A receiving lens 8 is positioned in front of each light receiver 5 and concentrates the light arriving within a receiving cone 9, which has an angle β, on the light receiver.

In the monitoring mode, i.e. when the monitoring field 1 is monitored to detect intruding objects, a control unit 10 activates the light emitter 3¹ and the light receiver 5¹ in a pair-wise fashion. During this brief time interval, only the light emitter 3¹ transmits light into the monitoring field 1, and at the same time only light receiver 5¹ is ready to receive light. In this manner, all light emitter/light receiver pairs, which are separated by a distance A, are briefly activated cyclically and sequentially in time. After all pairs have been activated, field 1 has been completely monitored.

In the distance determining mode, on the other hand, the control unit 10 only activates one light emitter, e.g. emitter 3³, and all light receivers 5¹, 5², 5³ to 5ⁿ at the same time or consecutively over a period of time. Given the emitter cone angle α shown in FIG. 1, as well as the distance A between adjacent light emitter/light receiver pairs and the width S of the monitoring field 1, the five light receivers 5¹ to 5ⁿ can see or recognize light emitter 3³. If the width S of the monitoring field 1 decreases, the number of light receivers 5 that can recognize light emitter 3³ becomes smaller. Similarly, the number increases as the field width S becomes larger.

Alternatively, it is also possible for the control unit to activate only one light receiver at a time, say receiver 5⁷, while operating in the distance determining mode. The other light emitters 3¹, 3², 3³ to 3ⁿ then emit their light one after the other. In this case as well, the number of emitters seen can be determined from the light signals picked up by light receiver 5⁷.

Since the emitter cone angle α, the receiving cone angle β and the distance A between adjacent light emitter/light receiver pairs are constant quantities, the width S of the monitoring field 1 can be determined with a table of concordances, for example, from the particular number of light receivers 5 seeing a given light emitter 3 or the number of light emitters 3 visible from a given light receiver 5.

The switching between the monitoring mode and the distance determining mode, triggered by the control unit 10, can be either cyclical or situation-dependent. In the case of a cyclical switching, for example, the switching process can be a permanent component of a repetitive activation process of the light emitter/light receiver pairs. That is, the distance determining mode will always take place just prior to or after all light emitter/light receiver pairs have been activated once.

A situation-dependent switching can be used, for example, if the distance determining mode is first activated when monitoring commences and the switch to the monitoring mode is only made thereafter.

As is also evident from FIG. 1, the light from a light emitter 3 directed into the monitoring field 1 is distributed over an ever larger beam cross-section by virtue of the transmitting cone 7 as the distance between the light emitter 3 and receiver 5 increases so that the light density will correspondingly diminish. As a consequence, less light reaches a given light receiver 5 with an increasing width S of the monitoring field 1. For this reason, an electrical input stage, not shown in FIG. 1, but connected in series to each light receiver 5, can be adjusted in its sensitivity so that even a low light density, as is encountered at the maximum width S of the monitoring field 1, can still be detected with certainty. This is accomplished, for example, by setting the switching threshold in the electrical input stage at a sufficiently low value so that the threshold is exceeded by the slight quantity of light that strikes receiver 5. If, however, the width S of the monitoring field 1 diminishes, then the light density increases correspondingly and so too does the electrical impulse generated by light receiver 5, and the switching threshold might be surpassed even if an object is in the monitored field. In these cases, there is a risk of uncertain recognition of an object, because even a slight amount of light, caused for example by reflections from machine surfaces in the vicinity of the monitoring field 1, can result in exceeding the switching threshold in the electrical input stage of the light receiver. This situation can be avoided by appropriately adjusting the switching threshold in the electrical input stage from the previously determined distance information.

Due to production and assembly tolerances, the emitter cone angle α and the receiving cone angle β can vary over a certain range, which can result in errors when determining the width S of monitoring field 1. This can be eliminated or at least reduced by having each light emitter and receiver learn its actual emitting cone angle α and the receiving cone angle β and then storing these values in a nonvolatile memory. In the distance determining mode, these values can be taken into account when determining the width S of the monitoring field.

The accuracy of determining the width S of the monitoring field 1 can be improved by determining the number of light emitters 3 visible from a light receiver 5 and/or the number of light receivers 5 which can see a light emitter 3 with several combinations of light emitters/light receivers. The final determination of the width S is then based on the mean value of the individual measurements.

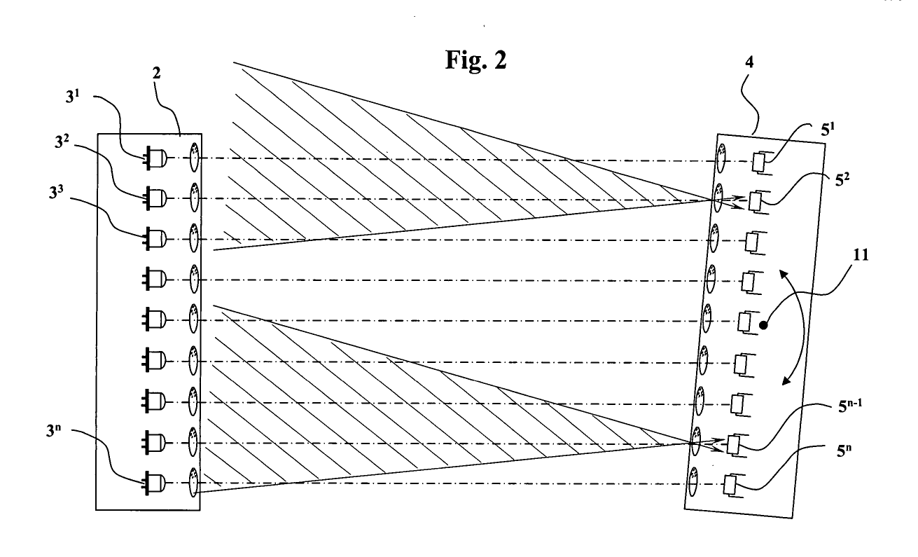

FIG. 2 shows a light grid, in which the emitter housing 2 with light emitters 3¹, 3², 3³ to 3ⁿ at one side of monitoring field 1 and the receiver housing 4 with light receivers 5¹, 5², 5³ to 5ⁿ at the opposite side of the monitoring field are not optimally aligned with each other. In such an event, the light grid in the distance determining mode can indicate that, as seen in FIG. 2, light receiver 52 can recognize three light emitters, while light receiver 5ⁿ⁻¹ receives light from five light emitters. If transmitter housing 4 is pivoted about an axis 11 perpendicular to the plane of the drawing, so that the two light receivers 5² and 5ⁿ⁻¹ can recognize precisely the same number of light emitters, the orientation of housings 2 and 4 can be properly adjusted.

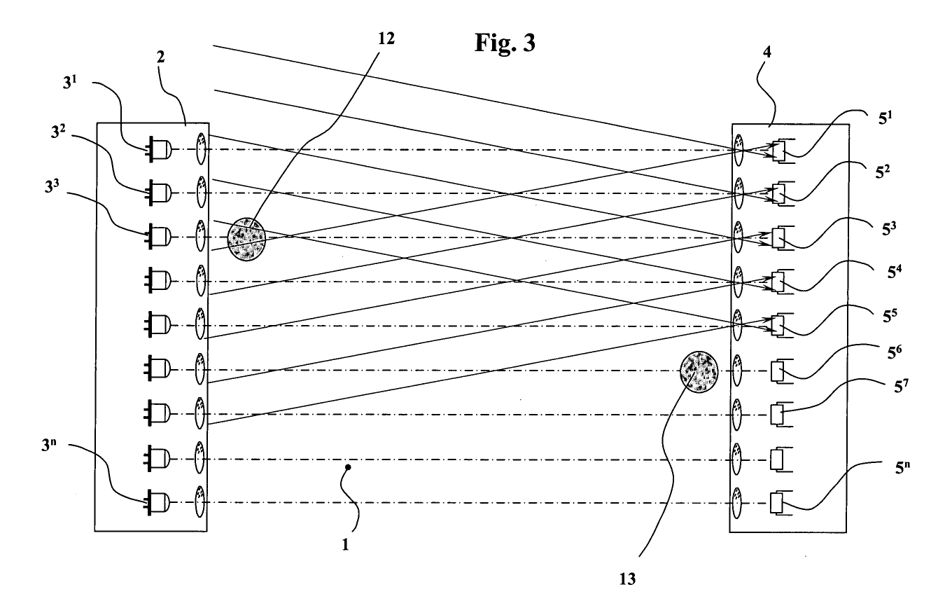

When in the distance determining mode, as shown in FIG. 3, it is not only possible to determine the width S of monitoring field 1 for adjusting the switching threshold and to compare the symmetry for help in aiming, but horizontal information for locating an object within the monitoring field 1 can also be obtained. The vertical information needed for locating the object is obtained from the light emitter/light receiver pairs whose light flux in the monitoring mode is interrupted by the object. It is further possible to obtain information about the size of the object. The horizontal information for locating can be derived from the number of light emitters 3 visible from a light receiver 5, as FIG. 3 shows. For example, if an object 12 is in the vicinity of light emitter 3, this object will be recognized by light receivers 5¹ to 5⁵ when operating in the distance determining mode. An object 13 in the vicinity of light receiver 5 will be recognized only by light receiver 5⁶. Thus, it is possible to determine horizontal information from the number of light receivers which recognize an object, obtained in the distance determining mode, and/or from the number of light emitters that are covered by the object.

The switching from the monitoring mode to the distance determining mode and back, under guidance of the control unit 10, can be done both cyclically and situation-dependent. Cyclical switching occurs, for example, when the distance determining mode is always briefly activated after a complete cycle of activating all light barrier pairs in the monitoring mode, for example, in order to check the settings of the two housings 2 and 4.

A situation-dependent switching is realized, for example, when the distance determining mode is activated each time the unit is placed in service or after each recognition of an object. At such time, the optimal setting of the switching threshold is checked and corrected if necessary. Only thereafter will the control unit 10 switch back to the monitoring mode.

1. A monitoring method comprising monitoring an area with a plurality of light emitters arranged alongside each other, which emit light along a light emitter cone (α), and a plurality of light receivers arranged alongside each other, which receive the light from a light receiver cone (β), arranging the emitters and receivers in interacting pairs which can be activated at least one of individually, sequentially and cyclically by a control unit during a monitoring mode of operation, and determining a distance (S) of the light emitters from the light receivers during a distance determining mode of operation from the number of light emitters visible by a light receiver and/or from the number of light receivers seeing a light emitter.

2. A method according to claim 1, wherein the control unit switches cyclically or in a situation-dependent manner between the monitoring mode of operation and the distance determining mode of operation.

3. A method according to claim 1, including tracking a switching threshold for the interacting pairs in the monitoring mode as a function of the distance (S) determined in the distance determining mode.

4. A method according to claim 1, including teaching a size of the emitting cone (α) and/or the receiving cone (β) at a factory.

5. A method according to claim 1, wherein determining the distance (S) between light emitters and light receivers in the distance determining mode includes correlating the number of light emitters visible from a given light receiver and/or the number of light receivers which see a given light emitter with a signal strength.

6. A method according to claim 1, wherein determining the distance (S) between light emitters and light receivers in the distance determining mode includes using a mean value of several light receivers.

7. A method according to claim 1, including using the number of light emitters seen from the light receivers and/or the number of light receivers seeing a light emitter for the aligning the light emitter housing with the light receiver housing.

8. A method according to claim 1, including using the number of light emitters seen from a light receiver and/or the number of light receivers seeing a light emitter for locating an object situated between the light emitter and the light receiver.

9. Apparatus for monitoring an area comprising a plurality of light emitters arranged alongside each other, which emit light along a light emitter cone (α), and a plurality of light receivers arranged alongside each other, which receive light from a light receiver cone (β), the emitters and receivers being arranged as a plurality of interacting pairs, a control unit for activating the interacting pairs at least one of individually, sequentially and cyclically during a monitoring mode of operation, the control unit being capable of determining the number of light emitters visible to a light receiver and/or the number of light receivers seeing a light emitter and therewith calculating a distance (S) between the light emitters and the light receivers.

10. Apparatus according to claim 9, wherein the control unit is adapted to cyclically or situation-dependently switch between the monitoring mode of operation and a distance determining mode of operation.

11. Apparatus according to claim 9, wherein a switching threshold for the interacting pairs can be tracked in the monitoring mode as a function of the distance information determined during the distance determining mode.

12. Apparatus according to claim 11, wherein the switching threshold for the interacting pairs can be determined by correlating a signal strength and the number of light emitters visible from a light receiver and/or the number of light receivers seeing a light emitter.
